(19) United States
(12) Patent Application Publication
(10) Pub. No.: US 2004/0003671 A1
(43) Pub. Date: Jan. 8, 2004

(54) Readjusting device for an unbalanced mass exciter

(76) Inventors: Wolfgang Fervers, Munchen (DE); Franz Riedl, Munchen (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/399,525

(22) PCT Filed: Nov. 21, 2001
(86) PCT No.: PCT/EP01/13570

(30) Foreign Application Priority Data
Nov. 22, 2000 (DE) 10057807.1

(51) Int. Cl. F16H 33/00

(52) U.S. Cl. 74/87; 74/61

(57) ABSTRACT

A readjusting device used to modify the functional parameters of an oscillator which comprises at least one rotatable unbalanced mass which is supported by a rotationally driveable shaft is provided with a rotationally mounted adjusting member on said shaft in order to modify the above-mentioned functional parameters and with an adjusting pin which is associated with the adjusting member, can be readjusted in an axial direction inside the shaft and which is arranged in such a way that it can rotate with the shaft. The adjusting pin which can be actuated by a controllable, non-rotating stamp and said stamp are disposed in an axial direction of the shaft in such a way that a crowned contour and a counter surface traversing the rotational axis of the shaft at a right angle touch each other in the center thereof relative to the axis of rotation.

In accordance with the preamble of claim 1, the invention relates to an adjusting device for the purpose of changing a functional parameter in the case of an oscillation exciter having at least one rotatable unbalanced mass which is supported by a rotationally driveable shaft, an adjusting member which is suitable for changing a functional parameter and is displaceably mounted on the shaft, an adjusting pin which is allocated to the adjusting member, can be adjusted in an axial direction inside the shaft and is arranged in such a manner as to rotate with the shaft, and having an operable, non-rotating stamp for the purpose of actuating the adjusting pin.

This type of adjusting device for an unbalanced mass oscillation exciter is known from EP 0 358 744 B1. Two mutually parallel shafts which can be set to perform rotational movements by way of a drive motor each support masses which are disposed in an eccentric manner. The rotational movement is transmitted from the first shaft in the opposite direction to the second shaft. The coupling member supports a toothed wheel which is in engagement with a toothed wheel on the first shaft. The second shaft is hollow and an adjusting pin can be displaced therein in an axial direction. The adjusting pin is provided with a pin which extends at a right-angle with respect to the axis of the shaft and which is guided outwards through axis-parallel longitudinal slits in the shaft and engages into a helical groove in the inner wall of the coupling member which surrounds the shaft. The adjusting pin can be displaced by means of a dual-acting hydraulic servomotor, causing the pin to be guided in the helical groove and causing an angular movement of the coupling member relative to the second shaft, which changes the phase position between the two shafts. As a consequence, it is possible to adjust the direction of a resulting force vector of the oscillation.

Since the servomotor is disposed on the oscillation exciter in a fixed housing and does not take part in the rotation of the shafts, this also applies to the stamp which transmits the adjusting force to the rotating adjusting pin. Therefore, the adjusting force between the stamp and the adjusting pin is transmitted by means of a roller bearing. The diameter, which is limited by virtue of the spatial ratios, of the hollow shaft which accommodates the adjusting pin also limits the diameter of the roller bearing and thus the load capacity thereof.

The inclusion of a roller bearing having sufficient load capacity into the transmission of force serves as an obstacle in particular to the wish to reduce the structural volume of an oscillation exciter or of another device having a correspondingly formed adjusting device. The sufficient dimensioning of the roller bearings also sets tight limits, if it is desired to shorten the adjusting path by reducing the pitch of the helical groove. In addition, the connection is to be produced and mounted in a relatively cost-intensive manner by means of a pressure-transmitting roller bearing.

Therefore, it is the object of the invention to provide an adjusting device of the type stated in the introduction which is able to function without roller bearings within the field of the transmission of adjusting force, and thus to reduce the structural volume and costs.

This object is achieved in accordance with the characterising features of claim 1 by virtue of the fact that the adjusting pin and the stamp lie against each other in the axial direction of the shaft in such a manner that a crowned contour contacts a counter surface, which traverses the rotational axis of the shaft at a right angle, in the centre thereof in relation to the axis of rotation.

As a consequence, the contact surface between the stamp and the adjusting pin is concentrated approximately to a point, in which in the region of the parts which slide on each other, the peripheral speed is practically zero. It is thus possible to dispense with roller bearings. In order to prolong the serviceable life, the contact surfaces between the crowned contour and the counter surface can be hardened.

In a particularly advantageous embodiment, the adjusting pin supports a diametrically extending pin which traverses axis-parallel longitudinal slits formed in the shaft and engages into a helical groove on the adjusting member.

Further advantageous embodiments are evident in the subordinate claims in conjunction with the description.

Overall, the inventive design gives rise to lower manufacturing costs by reason of lower material costs and lower assembly costs together with a greater degree of functional reliability. Moreover, it is possible to transmit greater forces which in turn saves on valuable structural volume.

The invention will be explained in detail with reference to the description hereinunder of an exemplified embodiment of the invention as illustrated in the drawing, in which

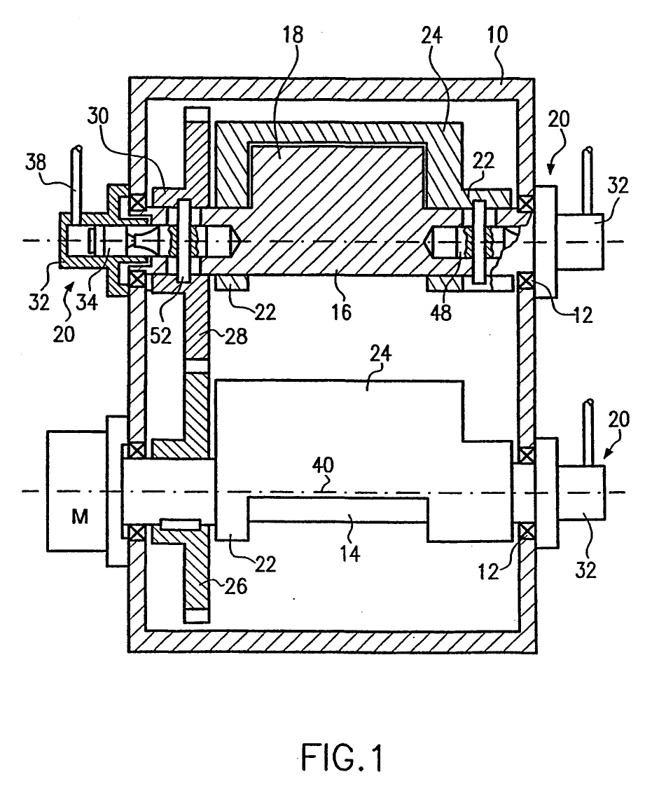

FIG. 1 shows a schematic sectional view of an oscillation exciter having two counter-rotating unbalanced shafts with a device for adapting the unbalanced mass between two different “m.r” values and a device for adjusting the phase position of the two unbalanced shafts, and

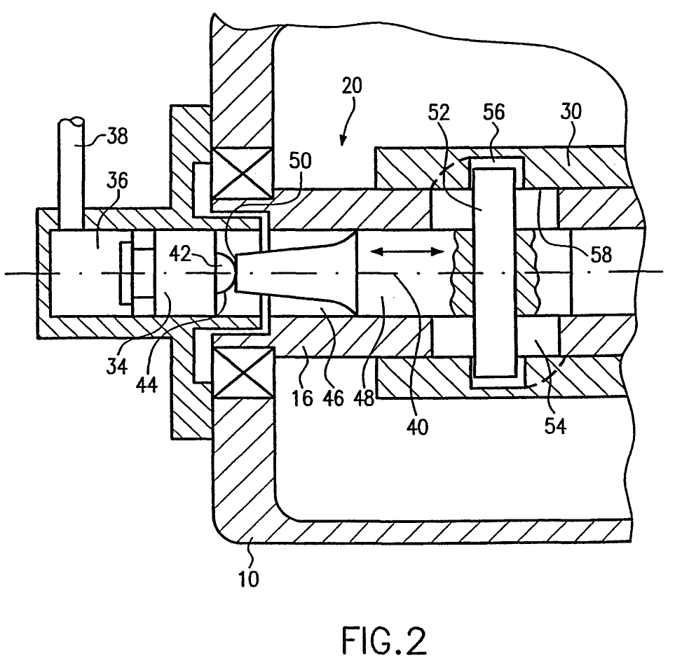

FIG. 2 shows the inventive embodiment of an adjusting device on an enlarged scale with respect to FIG. 1.

Like or corresponding elements are designated hereinunder by like reference numerals.

The oscillation exciter shown in FIG. 1 comprises a housing 10, in which there are mounted two mutually parallel shafts 14 and 16 by way of roller bearings 12, which shafts each comprise an eccentric mass 18 for the purpose of generating an unbalanced mass. Mounted on both shafts 14 and 16 are hubs 22 which can be pivoted by means of adjusting devices 20 but which are fixed in an axial direction and which support eccentric additional masses 24, the pivoting of which with respect to the mass 18 serves to change the eccentricity r of the total mass m generating the unbalanced mass, and thus serves to change the so-called “m.r” value. As will be described more precisely hereinunder, the adjusting devices 20 are configured in such a manner that irrespective of the adjusting movement a turning moment can be transmitted from the shafts 14 and 16 to the additional masses 24 which participate in the rotation of the shafts 14 and 16, which rotation can be generated by means of a drive motor M.

The motor M directly drives the shaft 14. The turning moment generated is transmitted by means of a toothed wheel 26, which is mounted in a non-rotational manner on the shaft 14, to a toothed wheel 28 which, in the same manner as the additional mass 22, is mounted in an axially fixed manner on the shaft 16 by means of a hub 30 and can be pivoted on the shaft 16 by means of an adjusting device 20 and, irrespective of this, is suitable for transmitting the turning moment to the shaft 16. By reason of the toothed wheel pair 26 and 28, the shafts 14 and 16 move in opposite directions. After a rotation of 180° in each case, the force vectors of the unbalanced masses of the two shafts are in parallel and act in the same direction, the maximum oscillation occurs. If the phase position of the two shafts 14 and 16 is changed in a known manner by adjusting the toothed wheel 28, the effective direction of the oscillation maximum changes accordingly, i.e. the direction of a resulting force vector is adjusted.

Each of the adjusting devices 20 comprises a cylinder 32 which is placed on to the housing 10 in a coaxial manner with respect to the respective shaft 14 or 16 and in which in an axially movable manner a piston or a stamp 34 is disposed in a movable manner such that on the side of the piston 34 remote from the shaft 14 or 16, there is located a pressure medium chamber 36 which can be influenced by a hydraulic medium via a line 38. On the side remote from the pressure medium chamber 36, the piston 34 is provided with a projection 42 which is disposed centrally with respect to the axis 40 of the shaft 14 or 16 and which terminates in a crowned contour 44 whose vertex is located on the axis 40. For example, the projection 42 can be produced by attaching a commercially available sphere to the piston 34.

In the interior of the respective shaft 14 or 16, the cavity 46 which opens towards the shaft end is provided with an axially displaceable adjusting pin 48 which at its end facing the open shaft end and thus the piston 34 is provided with a counter surface 50 which is allocated to the crowned contour 44. This counter surface 50 crosses the axis 40 at a right-angle, so that the crowned contour 44 in the centre of rotation has a practically point-like contact with this counter surface 50, in order to transmit the pressure prevailing in the pressure medium chamber 36 to the adjusting pin 48. This counter surface 50 can be formed in a planar manner, but due to structural considerations it can also be slightly convex or concave.

In the case of a different embodiment of the invention, the end face of the piston 34 is substantially planar, whereas the opposite end face of the adjusting pin 48 supports the crowned contour 44.

The adjusting pin 48 is traversed diametrically by a pin 52 which by means of a sliding fit traverses axis-parallel longitudinal slits 54, which are allocated to said pin, in the shaft 14 or 16 and engages into a helical groove 56 in a bearing surface 58 of the additional mass 24 or of the toothed wheel 28, which bearing surface surrounds the shaft 14 or 16 for pivot-mounting purposes.

If the hydraulic medium in the pressure medium chamber 36 causes the piston 34 in FIG. 2 to move to the right, the pin 52 moves accordingly and thereby generates an adjusting movement of the additional mass 24 or of the toothed wheel 28 about the shaft axis 40. The pitch of the groove 56 is selected in such a manner that by way of the flank of the groove 56 extending in an inclined manner with respect to the shaft axis 40, the turning moment transmitted from the toothed wheel 26 to the toothed wheel 28 generates at the pin 52 and thus at the adjusting pin 48 a force component which is effective in the axial direction and which is directed against the piston 34. This force component can be used as a restoring force, i.e. the adjusting movement of the adjusting device 20 is achieved in one direction by influencing the pressure medium chamber 36 with hydraulic medium, whereas the restoring movement can be controlled by lowering the hydraulic pressure and by effecting the inertia forces produced during rotation of the shafts 14, 16.

1. Adjusting device for the purpose of changing a functional parameter in an oscillation exciter, having
at least one rotatable unbalanced mass (18, 24) which is supported by a rotationally driveable shaft (14, 16);
an adjusting member (22, 30) which is suitable for the purpose of changing a functional parameter and is mounted in a rotatable manner on the shaft (14, 16);
an adjusting pin (48) which is allocated to the adjusting member (22, 30), can be adjusted in an axial direction inside the shaft (14, 16) and is disposed in such a manner as to rotate with the shaft; and having
an operable, non-rotating stamp (34) for the purpose of actuating the adjusting pin (48);
characterised in that the adjusting pin (48) and the stamp (34) lie against each other in the axial direction of the shaft (14, 16) such that a crowned contour (44) contacts a counter surface (50), which traverses the axis of rotation (40) of the shaft (14, 16) at a right angle, in the centre thereof in relation to the rotational axis (40).

2. Adjusting device as claimed in claim 1, characterised in that the crowned contour (44) is disposed on the stamp (34).

3. Adjusting device as claimed in any of claims 1 or 2, characterised in that the crowned contour (44) is formed by means of a sphere which is attached to the stamp (34) or to the adjusting pin (48).

4. Adjusting device as claimed in any of the preceding claims, characterised in that the counter surface (50) is slightly curved.

5. Adjusting device as claimed in any of the preceding claims, characterised in that the adjusting pin (48) supports a diametrically extending pin (52) which traverses axis-parallel longitudinal slits (54) formed in the shaft (14, 16) and engages into a helical groove (56) on the adjusting member (22, 30).
